(19) United States
(12) Patent Application Publication
(10) Pub. No.: US 2006/0192355 A1
(43) Pub. Date: Aug. 31, 2006

(54) Creeper apparatus

(75) Inventors: Richard M. Hulden, Taylors, SC (US); Chad James, Taylors, SC (US)

Correspondence Address: DORITY & MANNING, P.A., POST OFFICE BOX 1449, GREENVILLE, SC, 29602-1449, US

(73) Assignee: International Specialty Services, Inc.

(21) Appl. No.: 11/068,558

(22) Filed: Feb. 28, 2005

(51) Int. Cl. B25H 5/00

(52) U.S. Cl. 280/32.6

(57) ABSTRACT

A creeper apparatus is provided that includes a body portion with a longitudinal axis and a transverse axis perpendicular to the longitudinal axis. The body portion has a first end with first and second angled portions that extend so as to reduce the transverse length of the first end. The body portion has first and second side portions that extend from the first end and are substantially parallel to the longitudinal axis. The body portion also has a second end that extends from the first and second side portions along with a pair of casters that are attached to the body portion.

### CROSS-REFERENCE TO RELATED APPLICATIONS

N/A

### FEDERALLY SPONSORED RESEARCH OR DEVELOPMENT

N/A

### BACKGROUND

Creepers are used by mechanics in order to assist in providing access to the undercarriage of an automobile or other mechanism for purposes of repair or maintenance. Creepers usually include a body portion onto which a mechanic will lay. A headrest for the head of a mechanic is often provided as well. The mechanic typically lies on his or her back on a body portion of the creeper and positions the creeper to a desired location under the automobile or mechanism. Casters are attached to the body portion in order to allow the creeper to be easily moved in various directions by the mechanic.

The body portion is generally rectangular shaped and may be made, for instance, out of plywood or may be a structure that includes a metal frame that supports a padded body-supporting member onto which the mechanic lies. A rectangular shaped body portion is generally desirable because this shape accommodates the body of the mechanic and provides an advantageous wheelbase for the casters. The upper surface of the body portion is typically flat. The body portion could also be a molded member so as to be shaped in order to receive the torso, legs and/or head of the mechanic. It is sometimes the case that the square or rectangular shaped end of the body portion prohibits the mechanic from maneuvering the creeper under certain areas of the automobile or mechanism being serviced. In these instances, the mechanic is prohibited from gaining access to the necessary location or is required to work at an undesirable distance from the location in question.

Creepers that include a frame that supports a padded body-supporting member are generally configured so that the frame surrounds the perimeter of the padded body-supporting member. The top of the frame generally extends at the same vertical height so that the portion of the frame proximate to the mechanic's upper body is at the same height as that part of the frame proximate his or her lower body. It is sometimes the case that when a mechanic lies on the padded body-supporting member his or her torso or legs compress the padded body-supporting member and therefore rest on the frame. Alternatively, the frame may be above or at the same level as the padded body-supporting member so as to cause a similar engagement. Such a situation is undesirable in that the frame does not provide sufficient padding and may bite into the mechanic's legs or make it otherwise uncomfortable during use of the creeper.

Some creepers may be designed so that the upper surface of the padded body-supporting member is at the same vertical height as the upper surface of the top of the frame. This design sometimes results in pinching of the mechanic's shoulders. For instance, the weight of the mechanic may compress the padded body-supporting member so that his or her shoulder becomes pinched between the compressed padded body-supporting member and the adjacent frame. Additionally, it is sometimes the case that the headrests in creepers have flat upper surfaces onto which the mechanic's head will lie. This type of configuration may be undesirable in that it does not fit the natural shape of the human head. The comfort level of a mechanic during the use of a creeper may be important in that the mechanic may spend extended amounts of time using the creeper while fixing a problem with an automobile or other mechanism.

### SUMMARY

The present invention provides for an improved creeper that allows a mechanic to access a greater area underneath an automobile or other mechanism during servicing. An improved creeper is also provided with an end that has a frame that extends away from a body-supporting member of the creeper so that contact between the mechanic's legs or lower torso is either reduced, minimized or eliminated from the frame at the end of the creeper. This feature improves the comfort level of the mechanic during use of the creeper since the frame does not bite into the mechanic's legs or lower torso. Additionally, a creeper is provided that includes a padded body-supporting member with an upper surface that extends above the top of the frame of the creeper. This configuration prevents or minimizes pinching of the mechanic's clothing, hair, shoulders, or other body parts between the frame and the body-supporting member. Additionally, a concave portion into which the mechanic's head may rest so as to provide greater comfort to the mechanic during use is also provided. The present invention includes various exemplary embodiments of an improved creeper apparatus that incorporates one, all, or any combination of the aforementioned features.

Various features and advantages of the invention will be set forth in part in the following description, or may be obvious from the description, or may be learned from practice of the invention.

A creeper is provided that includes a body portion with a longitudinal axis and a transverse axis perpendicular to the longitudinal axis. The body portion has a first end with first and second angled portions. Each angled portion extends so as reduce the transverse length of the first end. The body portion also includes first and second side portions that extend from the first end. The first and second side portions are substantially parallel to the longitudinal axis, and the side portions extend a greater distance in the longitudinal direction than the first end. A second end is present and extends from the first and second side portions. A plurality of casters is attached to the body portion so as to enable movement of the creeper over a surface.

Also provided for is a creeper as discussed above in which the body portion includes a frame and a padded body-supporting member supported by the frame.

The creeper may also be configured in a manner as discussed above in which the first and second angled portions extend from the first and second side portions at an angle from between 140° and 160°.

Also provided is a creeper as discussed above that further includes a hinge attached to the body-supporting member in the first end and to the body-supporting member at a location intermediate the first and second side portions. The body-supporting member in the first end is adjustable with respect to the body-supporting member that is located intermediate the first and second side portions. A pin is also provided and is in engagement with the frame. The pin is configured to hold the body-supporting member in the first end in place after adjustment.

Also provided in another exemplary embodiment is a creeper that includes a body portion with a first end, second end, and an intermediate portion disposed between the first and second ends. The body portion has a frame and a body-supporting member supported by the frame. The body-supporting member in the intermediate portion defines an intermediate upper surface. At least a portion of the frame in the second end extends away from the intermediate upper surface so as to be below at least a portion of the frame in the intermediate portion. A plurality of casters is also provided and is attached to the body portion.

A creeper may also be provided as previously discussed in which the body-supporting member in the second end defines a second end upper surface. At least a portion of the frame in the second end extends away from the second end upper surface.

Another exemplary embodiment of the creeper exists as previously discussed in which the body-supporting member is padded.

Also provided in accordance with yet another exemplary embodiment is a creeper that has a body portion with a first end, second end, and an intermediate portion disposed between the first and second ends. The body portion includes a frame and a padded supporting member supported by the frame. The body-supporting member in the intermediate portion defines an intermediate upper surface that is non-adjustable and is configured for receiving the middle and lower part of the back of a user. The frame in the intermediate portion is located below the intermediate upper surface. Also, a plurality of casters is attached to the body portion.

Another exemplary embodiment exists as previously discussed in which the body-supporting member in the second end defines a second end upper surface. The frame in the second end is located below the second end upper surface.

Also provided is a creeper as immediately discussed in which the body-supporting member in the first end defines a first end upper surface. Further, the frame in the first end is located below the first end upper surface. Also, the first end upper surface is non-adjustable so as to be capable of being positioned at an angle to said intermediate upper surface.

Another exemplary embodiment of the creeper exists that includes a body portion with a first end, a second end, and an intermediate portion disposed between the first and second ends. The body portion has a frame and a padded body-supporting member that is supported by the frame. The body-supporting member in the first end defines a first end upper surface that defines a concave portion. Again, a plurality of casters may be attached to the body portion.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a top view of a creeper in accordance with one exemplary embodiment that has a first end with a reduced transverse length, a second end that has a portion of the frame that extends away from an intermediate upper surface of the creeper, and a body-supporting member with an upper surface that has a height above the top of the frame of the creeper.

FIG. 2 is a side view of the creeper of FIG. 1.

FIG. 3 is a side view of the creeper of FIG. 1 opposite to that of the side view of FIG. 2.

FIG. 4 is a bottom view of the creeper of FIG. 1.

FIG. 5 is a perspective view of a creeper that includes a first end with a reduced length in the transverse direction.

FIG. 6 is a perspective view of a creeper with a first end that has a reduced length in the transverse direction and a second end that has a frame that extends away from the upper surface of an intermediate portion of the creeper.

FIG. 7 is a perspective view of a creeper that has a second end with a frame that extends away from an intermediate upper surface of the creeper.

FIG. 8 is a perspective view of a creeper that includes a body-supporting member with an upper surface that extends above the height of the top of the frame of the creeper.

FIG. 9 is a perspective view of a creeper that has a first end with a first end upper surface that defines a concave portion for the mechanic's head.

FIG. 10 is a perspective view of a creeper that includes a first end with a first end upper surface that has a concave portion that extends across approximately one half of the longitudinal length of the body-supporting member in the first end.

FIG. 11 is a perspective view of a creeper that includes a first end with a reduced length in the transverse direction, and a second end with a frame that extends away from the intermediate upper surface of the creeper. The creeper also includes a body-supporting member with an upper surface that has a height greater than the top of the frame of the creeper, and the creeper has a first end upper surface that defines a concave portion for greater comfort of the user's head.

Repeat use of reference characters in the present specification and drawings is intended to represent same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to about 7 also includes a limit of to about 5, up to about 3, and up to about 4.5.

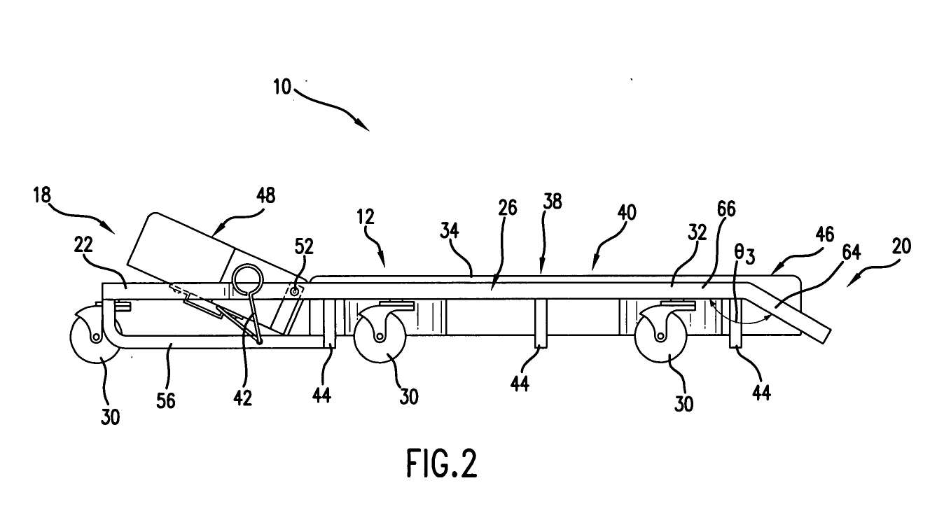

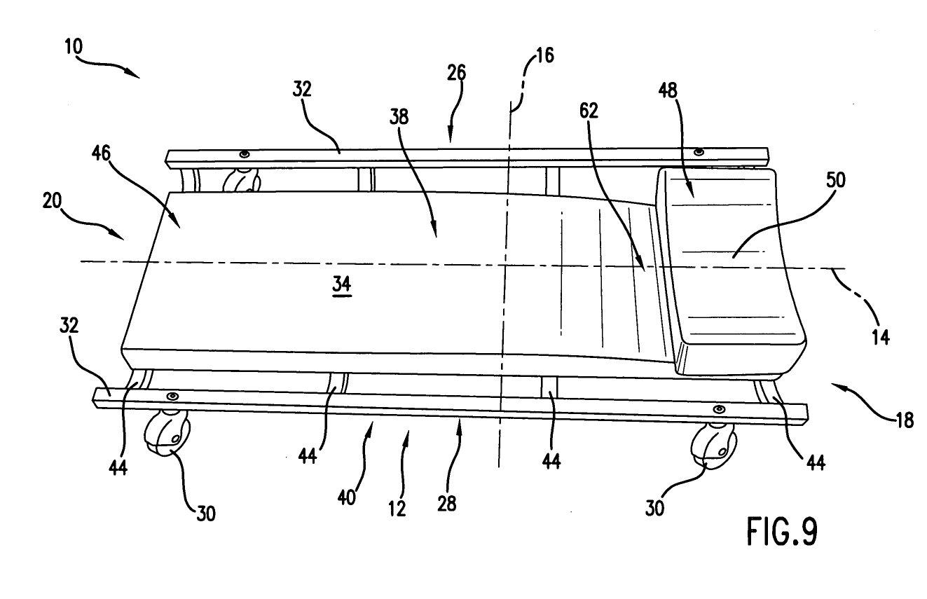

Referring to FIG. 2 for example, the present invention provides for an improved creeper apparatus 10 that may have an angled first end 18 that allows a mechanic to access additional areas under an automobile or mechanism being serviced while at the same time allowing the mechanic's eyes to be positioned closer to the area in question. In accordance with other exemplary embodiments, the creeper 10 may include a second end 20 that has a lowered frame portion 64 that extends below the portion of the frame 66 in an adjacent intermediate portion 40. This configuration may allow for the mechanic's legs and/or lower torso to extend from the creeper 10 so that contact with the frame 32 is prevented or minimized in order to increase the comfort of the mechanic. Additionally, referring to FIG. 2 for example, the present invention provides for exemplary embodiments in which a padded body-supporting member 34 extends above the frame 32 so as to prevent or minimize pinching that may occur on the mechanic's shoulders or other parts of the mechanic between the body-supporting member 34 and the frame 32. Further, referring to FIG. 9 for example, additional exemplary embodiments may exist in which the creeper 10 includes a first end upper surface 48 that defines a concave portion 50 so as to provide greater comfort to the head of the mechanic when the mechanic rests his or her head thereon. It is to be understood, however, that the present invention includes exemplary embodiments in which only one of the aforementioned features are included. Various exemplary embodiments also exist in which any combination or all of the aforementioned features are included.

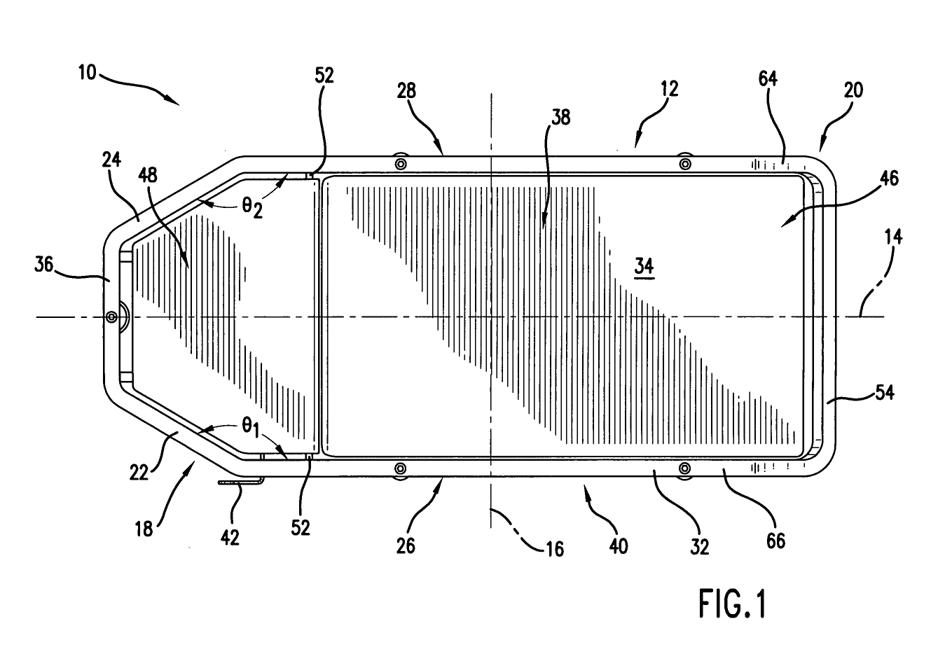

FIGS. 1-4 show a creeper 10 in accordance with one exemplary embodiment of the present invention. Here, the creeper 10 includes a body portion 12 with a frame 32 and a body-supporting member 34. The frame 32 is used in order to support the body-supporting member 34, and the body-supporting member 34 provides an area onto which the mechanic will lie.

The body portion 12 includes an intermediate portion 40 disposed between a first end 18 and a second end 20. Typically, the mechanic's head will be positioned at the first end 18 so that his or her torso or legs extend off the second end 20. The body-supporting member 34 may be padded so as to increase the comfort of the mechanic during use. Alternatively, the body-supporting member 34 need not be padded in other exemplary embodiments. For example, the body-supporting member 34 may be a sheet of metal or a surface made from plywood in accordance with other exemplary embodiments.

As shown in FIG. 1, the body portion 12 includes a longitudinal axis 14 and a transverse axis 16 that is perpendicular to the longitudinal axis 14. As shown in FIG. 1, the body portion 12 is elongated in the longitudinal direction. The body portion 12 also includes first and second side portions 26 and 28 that extend in the longitudinal direction. The first and second side portions 26 and 28 may be substantially parallel to one another such that they are substantially parallel to the longitudinal axis 14 in accordance with certain exemplary embodiments. Also, side portions 26 and 28 may extend in the longitudinal direction for a length longer than the longitudinal length of the first end 18 and/or second end 20.

Extending from the first side portion 26 is a first angled portion 22 of the frame 32. Likewise, extending from the second side portion 28 is a second angled portion 24 of the frame 32. As shown in FIG. 1 for example, the first angled portion 22 extends at an angle of ⊖₁ from the first side portion 26. ⊖₁ may be an angle from between 100°-175°, 120°-170°, 140°-160°, or may be 150°. ⊖₁ may be 45°-150°, 80°-130°, or may be 90°. ⊖₁ may be any angle up to about 150°, up to about 170°, or up to about 175° in accordance with various exemplary embodiments.

The second angled portion 24 extends at an angle ⊖₂ from the second side portion 28 in a similar manner as the first angled portion 22 and the first side portion 26 as previously discussed. Likewise, the angle ⊖₂ may be as that previously discussed with respect to ⊖₁. In accordance with one exemplary embodiment, ⊖₁ and ⊖₂ are at an angle from between about 140° and about 160°. Although shown as being equal to one another, it is to be understood that in accordance with other exemplary embodiments ⊖₁ may be an angle that is different than ⊖₂. For instance, in accordance with one exemplary embodiment ⊖₁ may be 135° while ⊖₂ is 160°. Likewise, ⊖₁ may be 178° while ⊖₂ is 148.5° in an alternative embodiment.

The first and second angled portions 22 and 24 are connected to a tip portion 36. The first and second angled portions 22 and 24 produce a resulting first end 18 that has a smaller footprint than if the first end 18 were square or rectangular shaped. As such, the creeper 10 will be able to be positioned into tighter spaces thus allowing the mechanic closer access to certain portions of the automobile or mechanism. Additionally or alternatively, the creeper 10 will be able to provide the mechanic with closer access to an area being serviced. In accordance with other exemplary embodiments, the first and second angled portions 22 and 24 do not both need to be provided. For instance, the first angled portion 22 may be provided with an angled ⊖₁ of 150° while the second angled portion 24 is provided with an angle ⊖₂ of 180° so that essentially only one side of the first end 18 is angled. Here, the first end 18 will still have a reduced footprint in order to provide additional access for the creeper 10.

The body-supporting member 34 in the intermediate portion 40 defines an intermediate upper surface 38. Likewise, the body-supporting member 34 in the first and second ends 18 and 20 define a first end upper surface 48 and a second end upper surface 46. The mechanic lies on surfaces 38, 46 and 48 when using the creeper 10 to access the underside of an automobile or other mechanism.

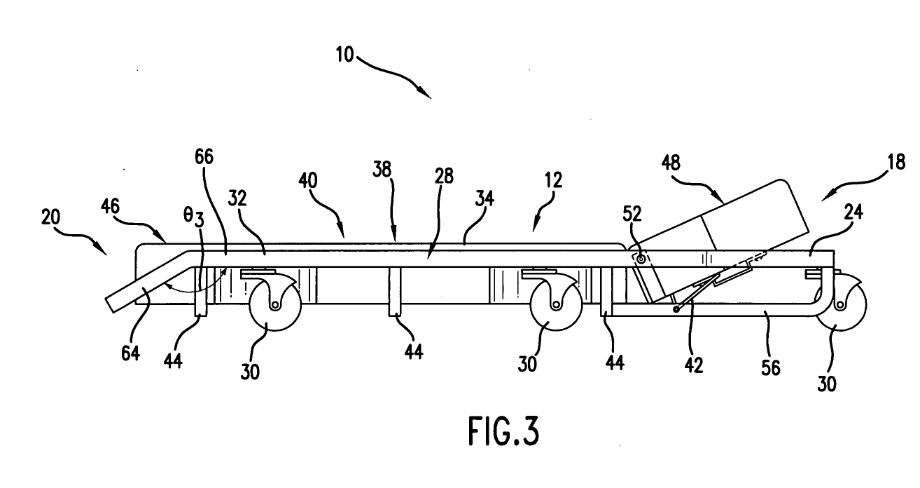

FIGS. 2 and 3 show side views of the second end 20 of the creeper 10. At least a portion 64 of the frame 32 in the second end 20 extends away from the intermediate upper surface 38 so as to be below at least a portion 66 of the frame 32 located in the intermediate portion 40. As shown in FIGS. 2 and 3, the lowered frame portion 64 desirably extends at an angle ⊖₃ that is approximately 150° from the portion 66 of the frame 32. It is to be understood, however, that in accordance with other exemplary embodiments the angle ⊖₃ may be greater than or less than 150°. For instance, ⊖₃ may be from 70°-170°, 90°-130°, or 130°-160°. Further, ⊖₃ may be up to about 175°, up to about 165°, or up to about 145° in accordance with other exemplary embodiments.

The second end upper surface 46 is at the same elevation as the intermediate upper surface 38. Angling of the frame 32 in the second end 20 results in a distance being defined between the portion 64 of the frame 32 in the second end 20 and the second end upper surface 46. This positioning helps prevent or minimize contact between the mechanic's legs or torso and the portion 64 of the frame 32 in the second end 20. Reduction or elimination of contact with the mechanic's legs or torso provides increased comfort because the portion 64 of the frame 32 in the second end 20, that is shown as including a back portion 54, does not bite into the legs or torso of the mechanic. The mechanic's legs or torso will be supported primarily by the body-supporting member 34 that is typically padded and hence acts to support the mechanic and provide increased comfort as opposed to the situation where the mechanic's legs or torso rests onto the frame 32 in the second end.

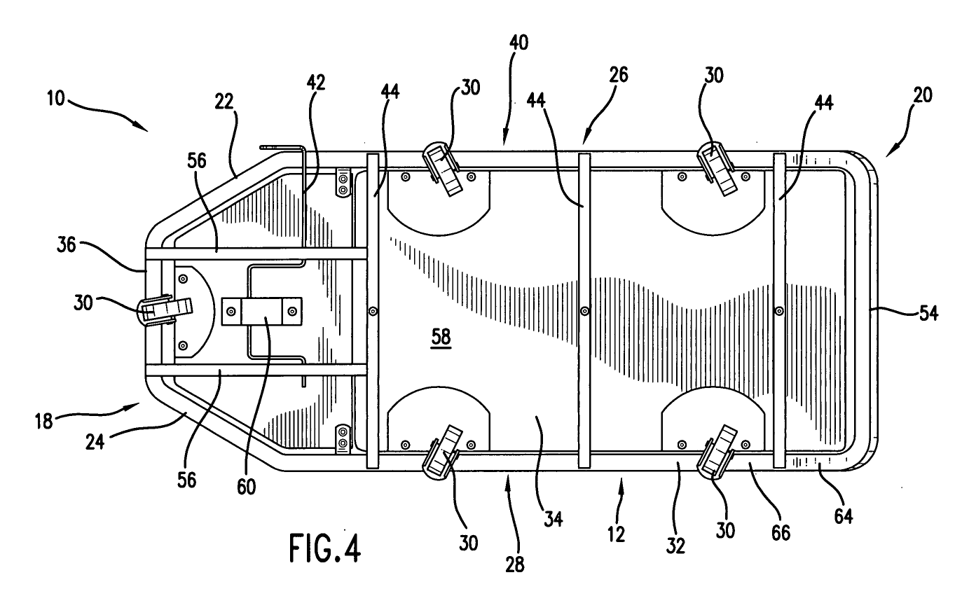

The underside of the creeper 10 is shown in FIG. 4 that notes the positioning of the casters 30. The casters 30 are stem-type casters mounted onto the frame 32. Five casters 30 are employed and are capable of rotating 360° so as to enable the creeper 10 to be moved in any direction on the surface onto which the creeper 10 rests. Although shown as employing five casters 30, it is to be understood that any suitable number of casters 30 may be used in accordance with various exemplary embodiments and that the casters 30 may be located at different locations on the body portion 12. For instance, the casters 30 may be mounted onto the body-supporting member 34 instead of or in addition to the frame 32. Any suitable caster 30 may be employed in the creeper 10. For instance, a 30 series caster having a wheel diameter of 3 inches and a pound capacity of 350 pounds with a wheel made of cast iron distributed by RWM Casters of 1225 Isley Road, Gastonia, N.C. 28053 may be employed. Although shown as employing a stem-type mounting, the casters 30 may have a rectangular mounting so as to be bolted, welded, or otherwise attached to the frame 32 in accordance with other exemplary embodiments. Further, although described as being capable of rotating 360° it is to be understood that the casters 30 may be selected so that they are only capable of rotating less than 360°. Further, the casters 30 may be selected so that they are not rotatable in accordance with various exemplary embodiments. In this case, the casters 30 are fixed so as to only allow the creeper 10 to move in a linear direction.

The body-supporting member 34 is a padded component so as to provide both support and comfort to the mechanic. The body-supporting member 34 may be made from several different layers of different material. For instance, the outer layer of the body-supporting member 34 that forms the surfaces 38, 46 and 48 may be made from any suitable type of material such as vinyl or cloth. Next, a foam material may be provided so as to provide for padding properties of the body-supporting member 34. Any suitable type of foam may be used. For example, the foam may be a neoprene, polyethylene, or EVA foam manufactured by Reed Rubber and Foam Products, 1615 North 25^{th} Street, Saint Louis, Mo. 63106. Beneath the foam, the body-supporting member 34 may include a piece of wood, such as plywood, so as to provide for structural support of the foam. Instead of wood, a flat piece of metal such as steel or aluminum may be used. The vinyl material or cloth material making up the surfaces 38, 46 and 48 may be wrapped around the wood layer and attached thereon. FIG. 4 shows a skirt 58, that may be made from a felt material, attached to the wood layer of the body-supporting member 34 for aesthetic purposes so that a user of the creeper 10 will not see the wood layer. The skirt 58 is shown stapled onto the wood layer of the body-supporting member 34, although various ways of attaching the skirt 58 may be employed. The skirt 58 and/or layers of the body-supporting member 34 may be attached to one another through bolts or other attachments commonly known to one having ordinary skill in the art. Although described as being multiple layers, it is to be understood that the body-supporting member 34 may be made of only a single layer in accordance with other exemplary embodiments. For instance, the body-supporting member 34 may be made from a single piece of plastic, aluminum, steel or wood in accordance with various exemplary embodiments.

A series of crossbars 44 are included in the frame 32 so as to help support the body-supporting member 34. The crossbars 44 can be bolted onto the body-supporting member 34 through the skirt 58. Although shown as employing three crossbars 44, it is to be understood that any number of, or zero, crossbars 44 may be used in accordance with other exemplary embodiments. Additionally, although shown as being substantially parallel to the transverse direction, the crossbars 44 may be angled in other exemplary embodiments so as to extend in both the longitudinal and transverse directions.

A pair of longitudinally extending bars 56 are also included and are attached to the frame 32 in the first end 18. The body-supporting member 34 in the first end 18 rests and is supported upon the longitudinally extending bars 56. The longitudinally extending bars 56 can be connected to one end of the crossbars 44 and the other ends of the bars 56 can be connected to the tip portion 36. The longitudinally extending bars 56 aid in supporting the body-supporting member 34 in the first end 18 due to the fact the body-supporting member 34 in the first end 18 is hingedly attached to the body-supporting member 34 in the intermediate portion 40.

Referring to FIG. 1, a hinge 52 may be employed so as to allow the body-supporting member 34 to pivot between the first end 18 and the intermediate portion 40. Hinge 52 is shown as a pin that extends through the body-supporting member 34 in the first end 18 and is retained on either end by the frame 32. The hinge 52 may be rotatably engaged or non-rotatably engaged with the frame 32. Additionally, the hinge 52 may be in engagement with wood or foam in the body-supporting member 34. The hinge 52 employed may be of any type commonly known to one having ordinary skill in the art and need not be configured as shown in the Figs. For example, a piano hinge distributed by Carroll Land Custom Furniture and Supply of Salisbury, N.C. may be used in accordance with one exemplary embodiment.

The hinge 52 may be attached proximate to the first end upper surface 48 and the intermediate upper surface 38 so as to allow the body-supporting member 34 in the first end 18 to pivot upwards with respect to the body-supporting member 34 in the intermediate portion 40. FIGS. 2 and 3 show the body-supporting member 34 in the first end 18 adjusted upwards so as to better support the head of the mechanic during use of the creeper 10. Any suitable mechanism may be employed in order to lock the body-supporting member 34 in the first end 18 in place when adjustment is desired. FIG. 4 shows a bracket 60 attached to the underside of the body-supporting member 34 and a pin 42 in engagement with the frame 32. The mechanic rotates the pin 42 so as to cause the body-supporting member 34 and the frame 32 to be moved upwards. Additionally or alternatively, the mechanic can also grasp the body-supporting member 34 in the first end 18 so as pivot this component upwards. Once adjusted into the desired location, the pin 42 will fall via gravity into a recess in the bracket 60 so as to effect a locking of the body-supporting member 34 in the first end 18.

Additional mechanisms may be employed in order to lock the body-supporting member 34 in the first end 18. For example, the body-supporting member 34 in the first end 18 may be adjusted upwards and the pin 42 can be inserted into apertures on either end of the upper portion of the frame 32. Release of the body-supporting member 34 in the first end 18 will cause this component to rest onto the pin 42. The mechanic can remove the pin 42 once additional adjustment is desired. It is to be understood that various mechanisms commonly known to one having ordinary skill in the art may be employed in order to effect adjustment of the body-supporting member 34 in the first end 18. The configurations shown and described are for sake of example and various designs to adjust and/or hold various parts of the creeper 10 are possible in accordance with various exemplary embodiments. Further, in accordance with various exemplary embodiments, the body-supporting member 34 in the first end 18 need not be adjustable.

Referring now to FIG. 2, the side view of the creeper 10 shows the intermediate upper surface 38 having a height above the frame 32 in the intermediate portion 40. Placement of the intermediate upper surface 38 in this manner prevents unwanted pinching of the shoulders or other portion of the mechanic between the body-supporting member 34 and the frame 32. Likewise, the first end upper surface 48 may be positioned above the frame 32 in the first end 18 when the body-supporting member 34 in the first end 18 is lowered from the raised position shown in FIG. 2. This arrangement may also help prevent unwanted pinching of the mechanic's hair, clothing or body as previously discussed.

The second end upper surface 46 may also be positioned above the frame 32 in the second end 20 in a similar manner as discussed with respect to the first end upper surface 48 and the intermediate upper surface 38. Any number of the surfaces 38, 46 or 48 may be above the frame 32 in accordance with various exemplary embodiments. For instance, the first and second end upper surfaces 48 and 46 may extend above the frame 32 while the intermediate upper surface 38 is located at or below the frame 32 in accordance with one exemplary embodiment. Further, exemplary embodiments exist in which only a portion of the intermediate upper surface 38 extends above the frame 32 while the rest of the intermediate upper surface 38 is located below the frame 32.

The height of the frame 32 may be located below the height of the intermediate upper surface 38, and the frame 32 may contact the body-supporting member 34 in the intermediate portion 40. The same may also be true for these components in the first and second ends 18 and 20. Alternatively, the frame 32 may be spaced from the body-supporting member 34 so that contact does not occur.

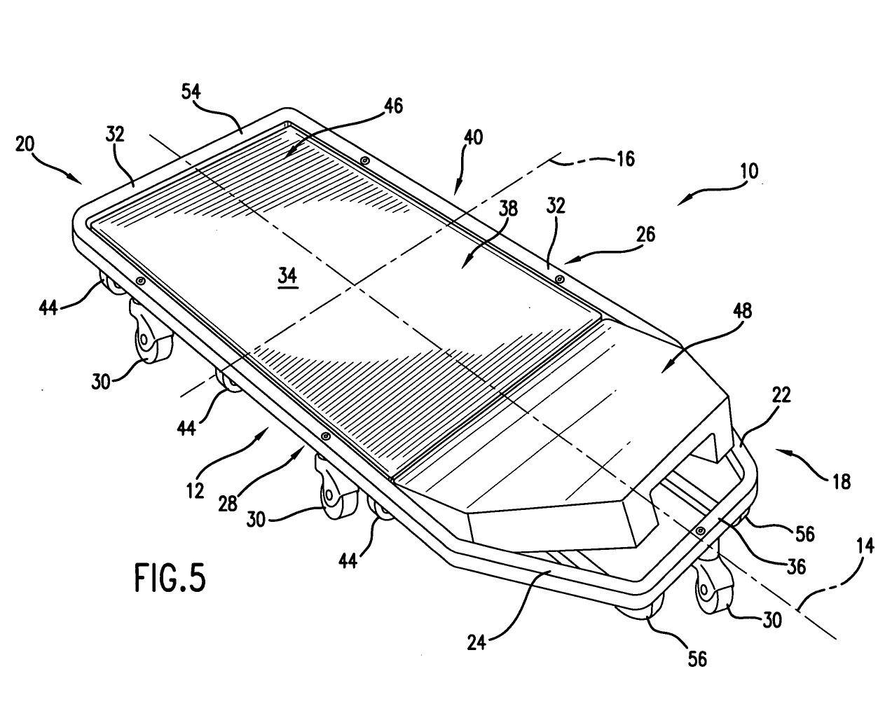

FIG. 5 shows an alternative exemplary embodiment in which first and second angled portions 22 and 24 are present so as to reduce the transverse length of the first end 18 to allow the creeper 10 to obtain access to tighter spaces underneath the automobile or mechanism being serviced. However, the frame 32 in the second end 20 is located at the same height as the frame 32 in the intermediate portion 40 so that the frame 32 in the second end 20 does not extend away from the intermediate upper surface 38. Additionally, the height of the surfaces 38, 46 and 48 are essentially the same as the height of the top of the frame 32.

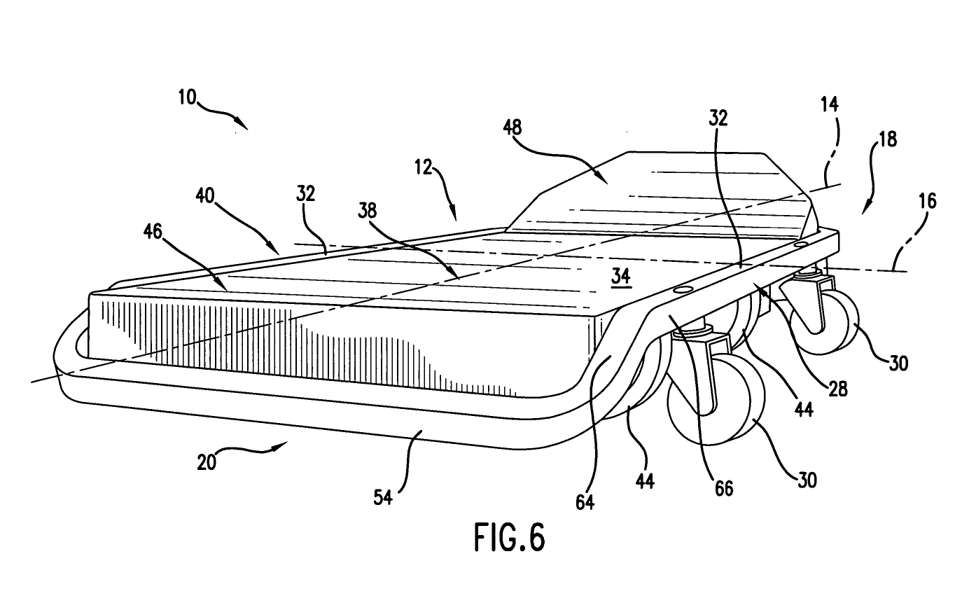

FIG. 6 shows an exemplary embodiment of the creeper 10 that is substantially similar to the one shown in FIGS. 1-4. However, the creeper 10 in FIG. 6 is different in that the intermediate upper surface 38 has a height that is the same as the top of the frame 32 in the intermediate portion 40. Additionally, the height of the first end upper surface 48 is the same as the height of the top of the frame 32 in the first end 18, although this feature is somewhat hard to distinguish since the body-supporting member 34 in the first end 18 is shown adjusted into an inclined position. As such, various exemplary embodiments of the present invention exist in which any combination of the aforementioned features may be included or removed.

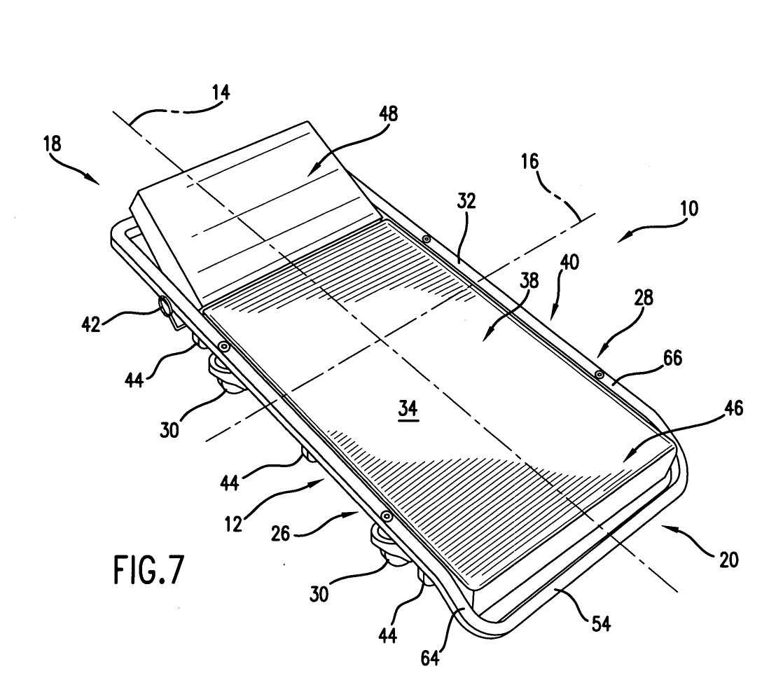

FIG. 7 shows another exemplary embodiment of the creeper 10 in which the first end 18 does not include first and second angled portions 22 and 24 and as such the transverse length of the first end 18 is substantially the same as the transverse length of the intermediate portion 40. Further, the exemplary embodiment shown in FIG. 7 is configured so that the height of the intermediate upper surface 38 is located at the same position as the height of the top of the frame 32 in the intermediate portion 40. Likewise, the height of the first end upper surface 48 is the same as the top of the frame 32 in the first end 18. The exemplary embodiment shown in FIG. 7 does include a lowered frame portion 64 in the second end 20 that extends away from the intermediate upper surface 38 so as to provide additional comfort to the lower torso or legs of the mechanic as described above with respect to other exemplary embodiments.

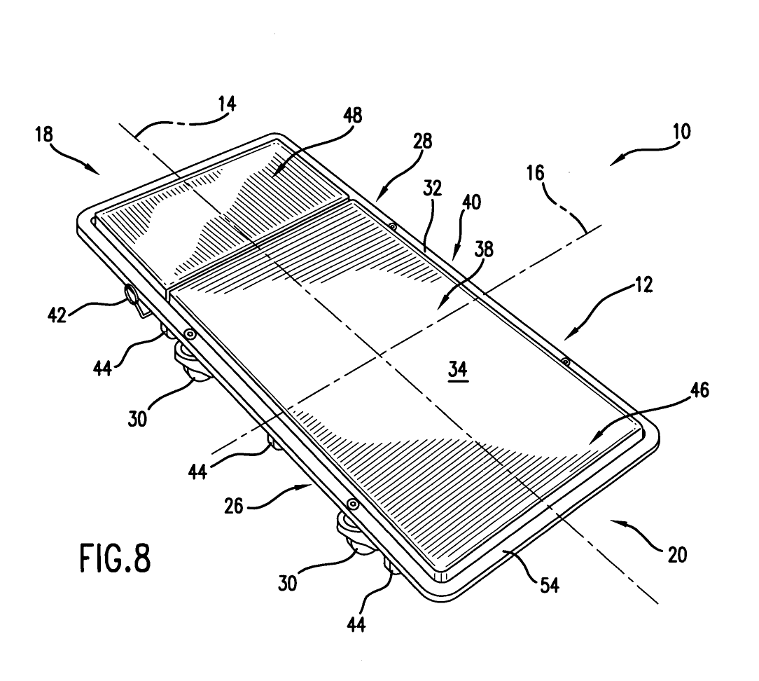

FIG. 8 shows yet another exemplary embodiment of the creeper 10 in which the first end 18 has a transverse length substantially the same as the transverse length of the intermediate portion 40. Further, no portion of the frame 32 in the second end 20 extends away from the intermediate upper surface 38. The body-supporting member 34, however, is raised from the frame 32 so that the surfaces 38, 46 and 48 have a height above the top of the frame 32. As previously mentioned, this configuration eliminates pinching of clothes, hair and other parts of the body of the mechanic. The intermediate upper surface 38 may be non-adjustable and may be configured to receive the middle and lower part of a user's back. For example, the intermediate upper surface 38 may support the user's latissimus dorsi muscles and the kidneys in accordance with one exemplary embodiment. The body-supporting member 34 in the first end 18 may be made so that it is adjustable with respect to the body-supporting member 34 in the intermediate portion 40 in a manner as previously discussed.

FIG. 9 is a perspective view of an exemplary embodiment of a creeper in accordance with the present invention. Here, the aforementioned features of the raised body-supporting member 34, reduced transverse length of the first end 18, and extension away from the intermediate upper surface 38 of the frame 32 in the second end 20 are not present. Instead, the creeper 10 includes a body-supporting member 34 in the first end 18 that has a first end upper surface 48 that defines a concave portion 50. The concave portion 50 provides for greater comfort of the mechanic's head during use of the creeper 10 as it more closely matches the natural contour of a human head. The concave portion 50 may be made by molding or cutting a piece of foam in the body-supporting member 34 of the first end 18 so that it has a depressed or curved surface. Vinyl or cloth may be placed over the shaped foam in a manner as previously discussed with respect to construction of the body-supporting member 34.

The concave portion 50 may extend across substantially the entire transverse length of the body-supporting member 34 in the first end 18, or the concave portion 50 may extend across only a part of the transverse length of the body-supporting member 34 in the first end 18 in accordance with other exemplary embodiments. For instance, the concave portion 50 may extend across one third of the transverse length of the body-supporting member 34 in the first end 18 while the remainder of the body-supporting member 34 in the first end 18 in the transverse direction has a planar first end upper surface 48. The concave portion 50 may extend in the longitudinal direction of the creeper 10 at any desired distance. For instance, the concave portion 50 may extend the entire longitudinal length of the first end 18 or may extend only along half of the longitudinal length of the first end 18. The concave portion 50 may have a depth of from between 1″-2″, 0.5″-2.5″, or 2″-5″ in accordance with various exemplary embodiments. Further, the maximum depth of the concave portion 50 may be up to 2″, up to 3″, or up to 5″ in accordance with various exemplary embodiments.

As shown in FIG. 9, the body-supporting member 34 may define a depressed area 62 thereon so as to allow for greater comfort of the mechanic's body proximate to the concave portion 50. However, it is to be understood that in accordance with other exemplary embodiments the body-supporting member 34 may be constructed so as to have an essentially planar upper surface aside from the concave portion 50.

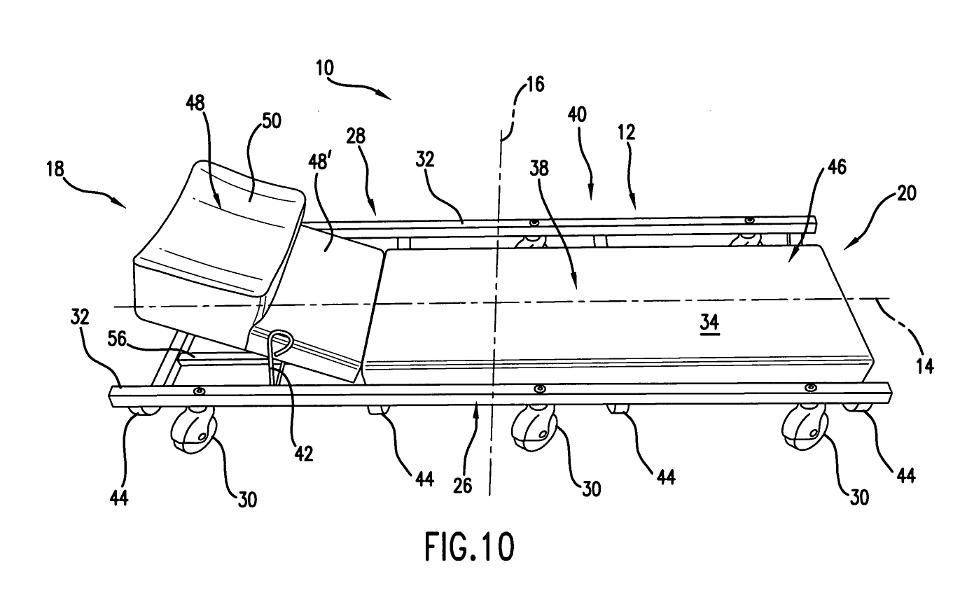

Another exemplary embodiment of the creeper 10 is shown in FIG. 10. Here, the creeper 10 includes a body portion 12 with a padded body-supporting member 34 carried by a frame 32 again supported on casters 30. The first end 18 has a raised portion that has a first end upper surface 48 that defines a concave portion 50. The concave portion 50 extends across approximately one half of the longitudinal length of the body-supporting member 34 in the first end 18. The remainder of the body-supporting member 34 in the first end 18 has a substantially planar upper surface 48′. The body-supporting member 34 in the first end 18 is hingedly attached to the body-supporting member 34 in the intermediate portion 40. The remainder of the body-supporting member 34 is planar and the frame 32 has sides that are substantially parallel to the longitudinal axis 14.

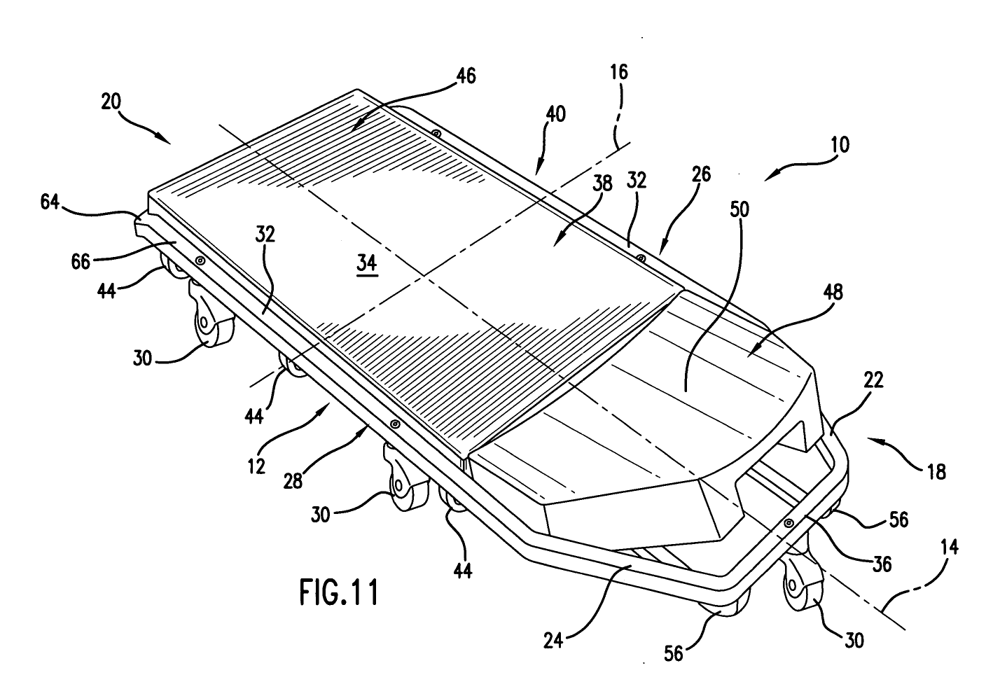

The concave portion 50 may be incorporated into the other exemplary embodiments of the creeper 10 as previously discussed with respect to FIGS. 1-8. FIG. 11 shows one such exemplary embodiment in which the creeper 10 includes essentially all of the previously discussed features. For example, the first end 18 is shortened in the transverse length and the second end 20 has a portion 64 of the frame 32 that extends away from the intermediate upper surface 38. Additionally, the height of each of the upper surfaces 38, 46 and 48 is above the height of each of the top of the frame 32. Still further, the creeper 10 of FIG. 11 includes a first end upper surface 48 that defines a concave portion 50 in order to provide greater comfort to the head of the mechanic during use of the creeper 10. It is therefore the case that the present invention provides for exemplary embodiments of the creeper 10 in which any of, any combination of, or all of the previously mentioned features are incorporated therein.

It should be understood that the present invention includes various modifications that can be made to the embodiments of the creeper 10 described herein as come within the scope of the appended claims and their equivalents.

What is claimed is:

1. A creeper, comprising:
a body portion having a longitudinal axis and a transverse axis perpendicular to said longitudinal axis, said body portion having a first end with first and second angled portions that extend so as to reduce the transverse length of said first end, said body portion having first and second side portions extending from said first end, said first and second side portions being substantially parallel to said longitudinal axis, said body portion having a second end extending from said first and second side portions, wherein said first and second side portions extend a greater distance in the longitudinal direction than said first end; and
a plurality of casters attached to said body portion.

2. The creeper as in claim 1, wherein said body portion has a frame and a padded body-supporting member supported by said frame.

3. The creeper as in claim 1, wherein said first end has a tip portion extending from said first and second angled portions, and wherein said tip portion is substantially parallel to said transverse axis.

4. The creeper as in claim 1, wherein said first and second angled portions extend from said first and second side portions at an angle from between about 140 degrees and about 160 degrees.

5. The creeper as in claim 1, wherein said body-supporting member in said first end defines a first end upper surface that defines a concave portion.

6. The creeper as in claim 2, further comprising:
a hinge attached to said body-supporting member in said first end and to said body-supporting member intermediate said first and second side portions, and wherein said body-supporting member in said first end is adjustable with respect to said body-supporting member intermediate said first and second side portions; and
a pin in engagement with said frame and configured for holding said body-supporting member in said first end in place after adjustment.

7. The creeper as in claim 2, wherein said frame has a plurality of crossbars that support said body-supporting member.

8. The creeper as in claim 2, wherein said body-supporting member intermediate said first and second side portions defines an intermediate upper surface, and wherein said frame in said second end extends away from said intermediate upper surface such that at least a portion of said frame in said second end is located below at least a portion of said frame in said first and second side portions.

9. The creeper as in claim 2, wherein said body-supporting member intermediate said first and second side portions defines an intermediate upper surface, and wherein said frame is located below said intermediate upper surface.

10. A creeper, comprising:
a body portion having a first end, a second end, and an intermediate portion disposed between said first and second ends, said body portion having a frame and a body-supporting member supported by said frame, wherein said body-supporting member in said intermediate portion defines an intermediate upper surface and wherein at least a portion of said frame in said second end extends away from said intermediate upper surface so as to be below at least a portion of said frame in said intermediate portion; and
a plurality of casters attached to said body portion.

11. The creeper as in claim 10, wherein said body-supporting member is padded.

12. The creeper as in claim 10, wherein said body-supporting member in said second end defines a second end upper surface, and wherein at least a portion of said frame in said second end extends away from said second end upper surface.

13. The creeper as in claim 10, wherein said body portion has a longitudinal axis and a transverse axis perpendicular to said longitudinal axis, and wherein said first end has first and second angled portions that extend so as to reduce the transverse length of said first end.

14. The creeper as in claim 10, wherein said frame in said intermediate portion is located below said intermediate upper surface.

15. The creeper as in claim 10, wherein said body-supporting member in said first end defines a first end upper surface that defines a concave portion.

16. A creeper, comprising:
a body portion having a first end, a second end, and an intermediate portion disposed between said first and second ends, said body portion having a frame and a padded body-supporting member supported by said frame, wherein said body-supporting member in said intermediate portion defines an intermediate upper surface that is non-adjustable and is configured for receiving the middle and lower part of the back of a user, and wherein said frame in said intermediate portion is located below said intermediate upper surface; and
a plurality of casters attached to said body portion.

17. The creeper as in claim 16, wherein said body-supporting member in said second end defines a second end upper surface, and wherein said frame in said second end is located below said second end upper surface.

18. The creeper as in claim 17, wherein said body-supporting member in said first end defines a first end upper surface, and wherein said frame in said first end is located below said first end upper surface, and wherein said first end upper surface is adjustable so as to be capable of being positioned at an angle to said intermediate upper surface.

19. The creeper as in claim 16, wherein at least a portion of said frame in said second end extends away from said intermediate upper surface so as to be located below at least a portion of said frame in said intermediate portion.

20. The creeper as in claim 17, wherein at least a portion of said frame in said second end extends away from said second end upper surface.

21. The creeper as in claim 16, wherein said body portion has a longitudinal axis and a transverse axis perpendicular to said longitudinal axis, and wherein said first end has first and second angled portions that extend so as to reduce the transverse length of said first end.

22. The creeper as in claim 16, wherein said body-supporting member in said first end defines a first end upper surface that defines a concave portion.

23. A creeper, comprising:
a body portion having a first end, a second end, and an intermediate portion disposed between said first and second ends, said body portion having a frame and a padded body-supporting member supported by said frame, wherein said body-supporting member in said first end defines a first end upper surface that defines a concave portion; and
a plurality of casters attached to said body portion.

24. The creeper as in claim 23, further comprising:
a hinge attached to said body-supporting member in said first end and to said body-supporting member in said intermediate portion, and wherein said body-supporting member in said first end is adjustable with respect to said body-supporting member in said intermediate portion; and
a pin in engagement with said frame and configured for holding said body-supporting member in said first end in place after adjustment.
